(19) United States
(12) Patent Application Publication
(10) Pub. No.: US 2025/0298489 A1
(43) Pub. Date: Sep. 25, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Bo LIU, Kanagawa (JP); Naoto Yamasaki, Kanagawa (JP); Naoya Ueda, Kanagawa (JP); Kimihiko Sasaki, Kanagawa (JP)

(73) Assignee: FUJIFILM Business Innovation Corp., Tokyo (JP)

(21) Appl. No.: 18/770,579

(22) Filed: Jul. 11, 2024

(30) Foreign Application Priority Data
Mar. 21, 2024 (JP) 2024-045737

(51) Int. Cl. G06F 3/04817; G06F 3/0482; G06F 3/0484

(52) U.S. Cl. CPC G06F 3/04817; G06F 3/0482; G06F 3/0484

(57) ABSTRACT

An information processing system includes one or plural processors configured to display a workflow in which a processing icon representing processing and a branch icon representing branching by a conditional branching are arranged, receive the processing icon included in a post-branching flow of one condition after the branching of the branch icon as a replication target, and in a case where a replication destination of the processing icon as the replication target is a post-branching flow of the other condition after the branching, dispose the processing icon whose item changeable based on the other condition, among items of an attribute of processing of the processing icon as the replication target, is changed from the one condition, based on the other condition, at the replication destination.

### CROSS-REFERENCE TO RELATED APPLICATIONS

This application is based on and claims priority under 35 USC 119 from Japanese Patent Application No. 2024-045737 filed Mar. 21, 2024.

### BACKGROUND

### (i) Technical Field

The present invention relates to an information processing system, a non-transitory computer readable medium storing a program, and an information processing method.

### (ii) Related Art

JP2020-42590A discloses a technique related to an information processing apparatus and a workflow editing method, particularly, a technique related to editing of a workflow for creating a product in, for example, commercial printing. In the related art, in print workflow setting software, an operation of a step associated with information of parts constituting the product is received. In a case where the received operation is to add a step, the added step is acquired. In a case where the acquired step is a joining step, a physical positional relationship between the parts is determined. Thereafter, in a case where the determined positional relationship between the parts is a relationship between a main text and a cover, a setting value of another part is calculated based on a received setting value, and the calculated setting value is set for another part.

### SUMMARY

Aspects of non-limiting embodiments of the present disclosure relate to an information processing system, a non-transitory computer readable medium storing a program, and an information processing method that improve work efficiency of creating a workflow, compared with a case where an attribute of an icon at a replication destination is replicated without changing the attribute at all.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to display a workflow in which a processing icon representing processing and a branch icon representing branching by a conditional branching are arranged, receive the processing icon included in a post-branching flow of one condition after the branching of the branch icon as a replication target, and in a case where a replication destination of the processing icon as the replication target is a post-branching flow of the other condition after the branching, dispose the processing icon whose item changeable based on the other condition, among items of an attribute of processing of the processing icon as the replication target, is changed from the one condition, based on the other condition, at the replication destination.

### BRIEF DESCRIPTION OF THE DRAWINGS

Exemplary embodiment(s) of the present invention will be described in detail based on the following figures, wherein:

FIG. 1 is a block diagram of a hardware configuration of an information processing apparatus;

FIG. 2 is a diagram of a workflow creation screen displayed on a display unit;

FIG. 3 is a diagram showing a state in which a processing icon as a replication target of a workflow is selected on the workflow creation screen of FIG. 2;

FIG. 4A is a diagram of a watermark of a replication source, and FIG. 4B is a diagram showing a watermark of a replication destination;

FIG. 5 is a diagram of an attribute setting screen of the processing icon (watermark) of a replication source;

FIG. 6 is a diagram of the attribute setting screen of the processing icon (watermark) of the replication destination; and

FIG. 7 is a flowchart of replication processing.

### DETAILED DESCRIPTION

### Exemplary Embodiment

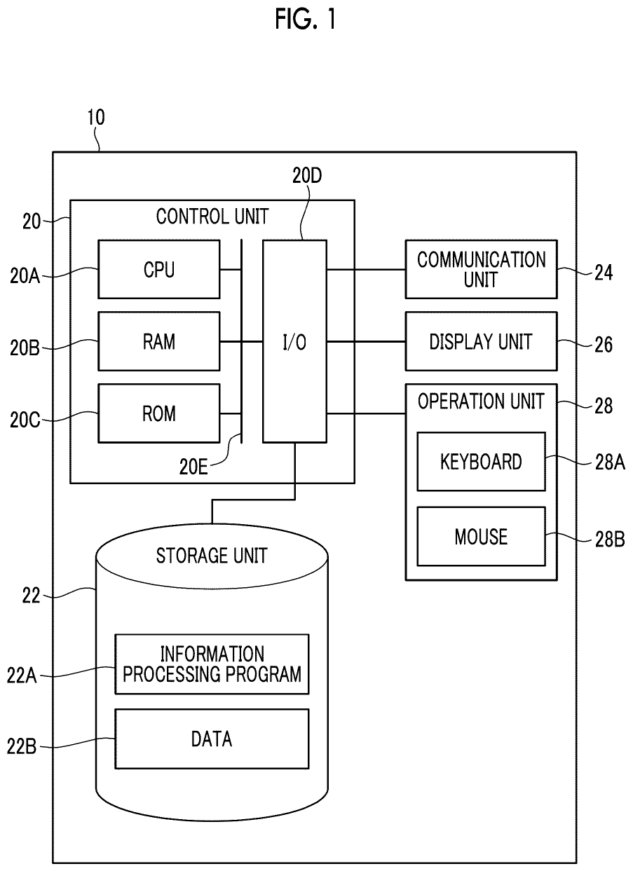

An information processing apparatus 10 according to the present exemplary embodiment as an example of an information processing system shown in FIG. 1 is a computer system that creates a workflow in pre-press, which is a pre-printing step. Further, as an example, a general-purpose computer device such as a server computer and a personal computer is applied to the information processing apparatus 10.

### Hardware Configuration

FIG. 1 is a block diagram showing an example of an electrical hardware configuration of the information processing apparatus 10 as an example of the information processing system. As shown in FIG. 1, the information processing apparatus 10 according to the present exemplary embodiment includes a control unit 20, a storage unit 22, a communication unit 24, a display unit 26, and an operation unit 28.

A central processing unit (CPU) 20A, a random access memory (RAM) 20B, a read only memory (ROM) 20C, and an input/output interface (I/O) 20D are included in the control unit 20, and are connected to each other via a bus 20E. Here, the CPU 20A is an example of a processor.

Functional units including the storage unit 22, the communication unit 24, the display unit 26, and the operation unit 28 are connected to the I/O 20D. Each of these functional units can communicate with the CPU 20A via an I/O 20D.

As the storage unit 22, for example, auxiliary storage devices such as a hard disk drive (HDD), a solid state drive (SSD), and a flash memory are used. The storage unit 22 stores an information processing program 22A for realizing information processing according to the present exemplary embodiment, various types of data 22B, and the like.

The CPU 20A reads out the information processing program 22A from the storage unit 22 and develops the information processing program 22A into the RAM 20B to execute the processing. Accordingly, the information processing apparatus 10 that has executed the information processing program 22A operates as the information processing apparatus 10 of the present disclosure. The information processing program 22A may be stored in the ROM 20C.

The operation unit 28 is provided with, for example, a device for operation input, such as a keyboard 28A and a mouse 28B, and receives various instructions from a user. The communication unit 24 is connected to a network NT such as the Internet, a LAN, or a WAN, and is capable of communicating with an external device via the network NT.

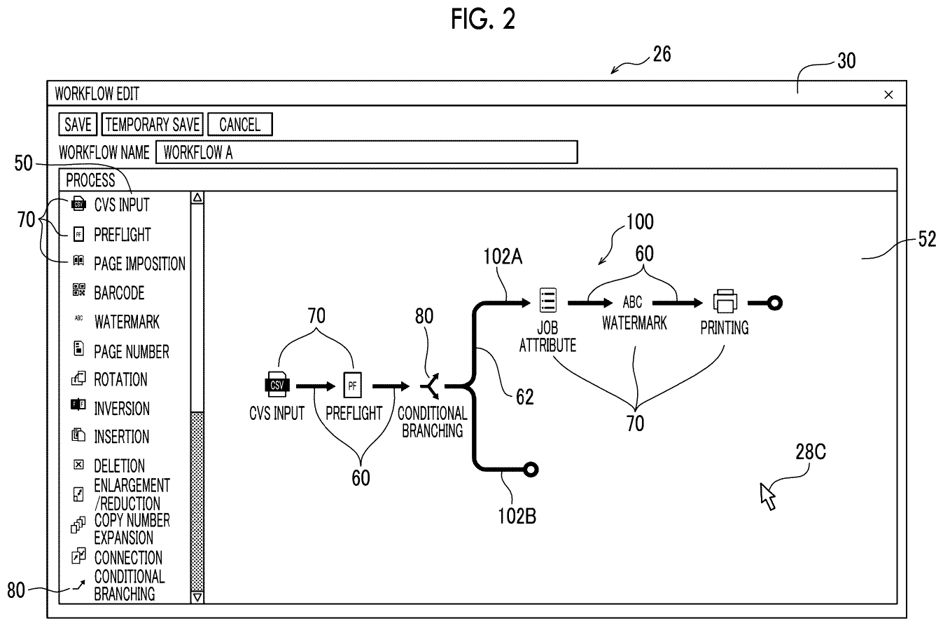

For example, a liquid crystal display (LCD) or the like is used as the display unit 26 (refer to FIG. 2). The display unit 26 displays various types of information such as a result of the processing executed in response to the instruction received from the user and a notification on the processing. Further, in the present exemplary embodiment, as shown in FIG. 2, the display unit 26 displays a workflow creation screen 30 for creating a workflow 100.

### Workflow Creation

Next, the creation of the workflow 100 (refer to FIG. 2) using the information processing apparatus 10 shown in FIG. 1 will be described. In addition, the “workflow” in the present exemplary embodiment is a flow of processing in the pre-press. The “processing” is processing that constitutes the pre-press and can be operated independently, and can be paraphrased as “process”. For example, there are processing of setting a page imposition, processing of assigning a page number, processing of deleting a page, and processing of inserting a watermark. Further, the “creation of workflow” is not limited to a case where the workflow is created from scratch, and includes, for example, a case where a created workflow stored in the storage unit 22 is read out and edited.

FIG. 2 is a display example on the workflow creation screen 30 of the display unit 26 in a case where the user creates the workflow 100.

In the workflow creation screen 30 according to the present exemplary embodiment, a left end is a list display unit 50 that displays, as an example of icons, a processing icon 70 and a branch icon 80. The processing icon 70 is an icon representing processing. The branch icon 80 is an icon representing branching based on a condition for conditional branching.

In a case where the processing icons 70 are distinguished from each other, processing names are described in parentheses before the reference numeral 70. In the example of FIG. 2, the processing icon (CVC input) 70, the processing icon (preflight) 70, the processing icon (job attribute) 70, the processing icon (watermark) 70, and the processing icon (printing) 70 are disposed from a left side. Further, the branching condition of the branch icon 80 is branching based on a color mode. The “CSV input” is processing of inputting data included in a CSV file to manuscript data using the CSV file, the “preflight” is processing of checking whether or not there is any defect in a content of the input manuscript data, the “job attribute” is processing of changing or adding an attribute used in a case where the manuscript data is printed, the “watermark” is processing of inserting the watermark, and the “printing” is processing of performing printing. Further, the “manuscript data” in the present exemplary embodiment is a PDF, but the present disclosure is not limited thereto. For example, a Word file or a Docuworks (registered trademark) file may be used.

Further, flows after the branching by the branch icon 80 in the workflow 100 according to the present exemplary embodiment are referred to as a post-branching flow 102A and a post-branching flow 102B. The condition for the conditional branching of the branch icon 80 is the color mode, a color mode condition of the post-branching flow 102A is monochrome, and the color mode condition of the post-branching flow 102B is color.

A right side of the list display unit 50 on the workflow creation screen 30 is a workflow creation unit 52. The user drags and drops the processing icon 70 and the branch icon 80 of the list display unit 50 with a mouse or the like to be disposed and arranged in the workflow creation unit 52 to create the workflow 100.

Further, a processing line 60 connecting the processing icons 70 and a branch line 62 representing the branching are automatically displayed in a case where the processing icons 70 and the branch icons 80 are arranged.

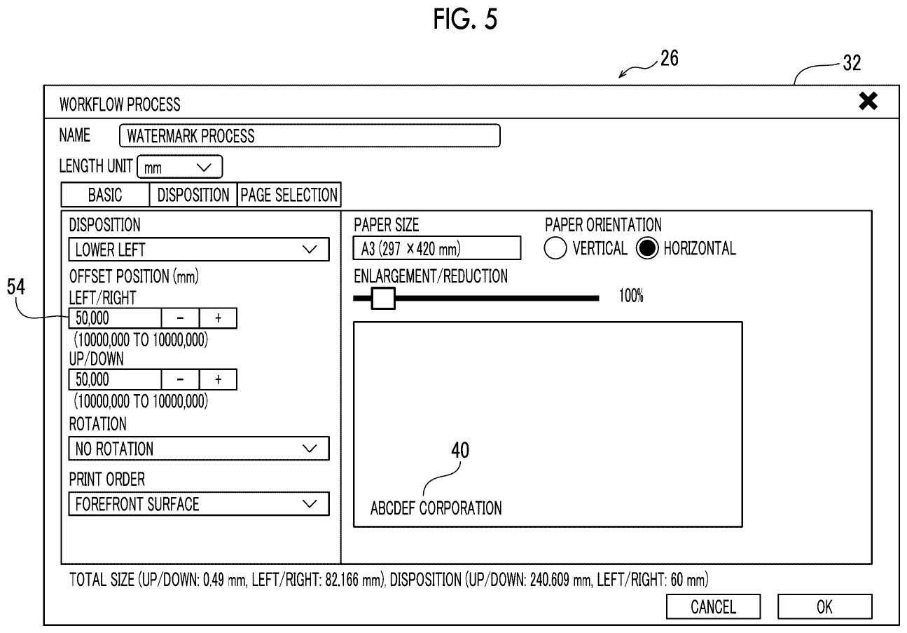

Further, with a predetermined operation on the processing icon 70 and the branch icon 80, for example, alignment of a mouse pointer 28C with the processing icon 70 and the branch icon 80 and right-clicking of the mouse 28B (refer to FIG. 1), an attribute setting screen 32 shown in FIG. 5 is displayed, and the user sets each item of the attribute of each piece of processing. The “attribute” is a setting in which the user can change a result of the processing by making a change, and can be paraphrased as a “property”. Further, the “item of attribute” is a changeable setting item in the attribute, and is, for example, a disposition or an offset position on a left side in FIG. 5.

Here, FIG. 5 is the attribute setting screen 32 of the processing icon (watermark) 70, and the attribute setting screen 32 is set according to the processing represented by the processing icon 70 and the branch icon 80.

### Replication Function

Next, a replication function will be described.

The information processing apparatus 10 shown in FIG. 1 has the replication function of selecting one or a plurality of the processing icons 70 disposed and arranged in the workflow creation unit 52 of FIG. 2 and replicating the selected processing icon 70 in another place.

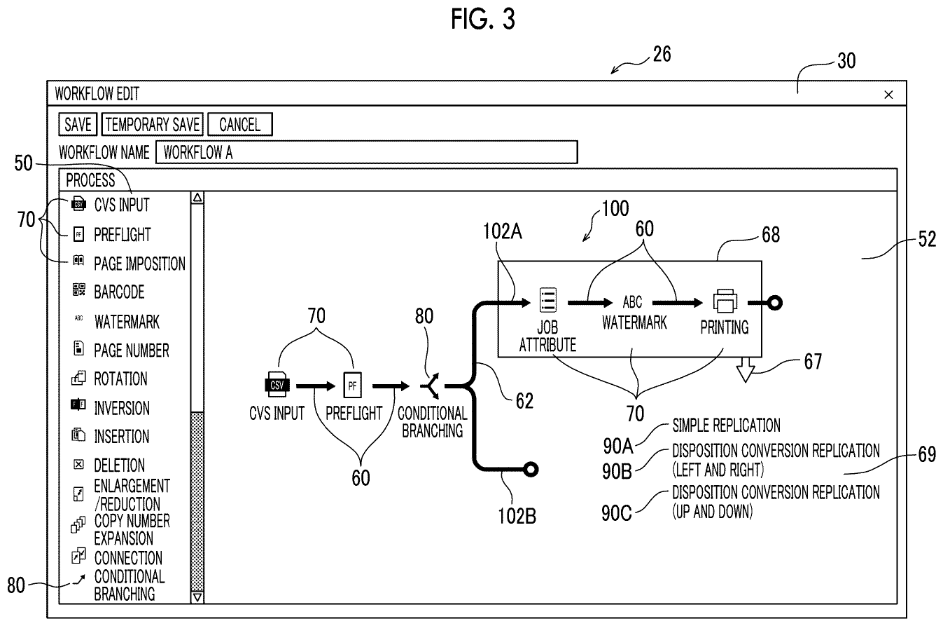

In the present exemplary embodiment, as shown in FIG. 3, in a case where the user performs a predetermined operation, for example, operates the mouse pointer 28C or the like with the mouse 28B (refer to FIG. 1) to select one or a plurality of the processing icons 70, a frame 68 surrounding the selected processing icon 70 is displayed, and a replication destination arrow 67 indicating a replication destination where the replication is possible is displayed. In the example of FIG. 3, since the replication destination where the replication is possible is only a lower side, only the replication destination arrow 67 is displayed. However, in a case where there are a plurality of replication destinations, the replication destination arrow 67 is displayed for each replication destination.

In a case where the replication destination arrow 67 of the replication destination is selected, a list 69 of replication modes 90A, 90B, and 90C is displayed. In addition, in a case where the replication modes 90A, 90B, and 90C are described without being distinguished from each other, A, B, and C after the reference numeral 90 are omitted.

In a case where any of the replication modes 90A, 90B, and 90C in the list 69 is selected by the operation of the user, the attribute of the processing icon 70 whose attribute is changeable according to the selected replication mode 90 is changed according to the replication mode 90, and the processing icon 70 is replicated to the replication destination. The description of the replication modes 90A, 90B, and 90C will be described below.

### Replication Mode

Next, the replication mode 90 will be described.

The replication mode 90 is a mode in which the attribute of the processing of the processing icon 70 is automatically changed.

As shown in FIG. 3, in a case where the user selects one or a plurality of the processing icons 70 of one post-branching flow 102A after the branch icon 80 and replicates the selected processing icon 70 to the other post-branching flow 102B after the branch icon 80, the attribute of the processing icon 70 whose attribute is changeable based on the replication mode 90 is changed based on the replication mode 90 and the processing icon 70 is disposed on the post-branching flow 102B as the replication destination.

In the present exemplary embodiment, the three replication modes 90A, 90B, and 90C are provided. The replication mode 90A is a simple replication mode in which the processing icon is replicated without changing the attribute of the processing. The replication mode 90B is a mode of performing a disposition conversion replication (left and right) in which the left/right disposition of print, the page number, the watermark, and the like is switched. The replication mode 90C is a mode of performing the disposition conversion replication (up and down) in which the disposition of the print, the page number, the watermark, and the like is switched up and down.

For example, in a case where the replication mode 90B of performing the disposition conversion replication (left and right) is selected, the processing icon capable of being subjected to the disposition conversion replication (left and right), among the processing icon (job attribute) 70, the processing icon (watermark) 70, and the processing icon (printing) 70, is the processing icon (watermark) 70 in the example of FIG. 3. Thus, the left/right disposition of the watermark is switched from the post-branching flow 102A of a replication source, and the processing icon 70 is replicated to the post-branching flow 102B of the replication destination to be disposed.

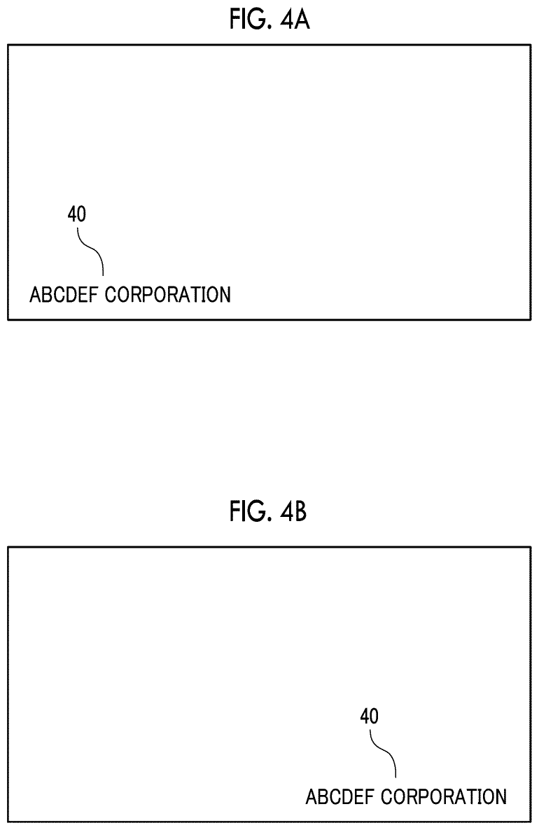

In the example of FIG. 3, in the post-branching flow 102A of the replication source, a watermark 40 located at a left end as shown in FIG. 4A is moved to a right end as shown in FIG. 4B in the post-branching flow 102B (refer to FIG. 3) of the replication destination.

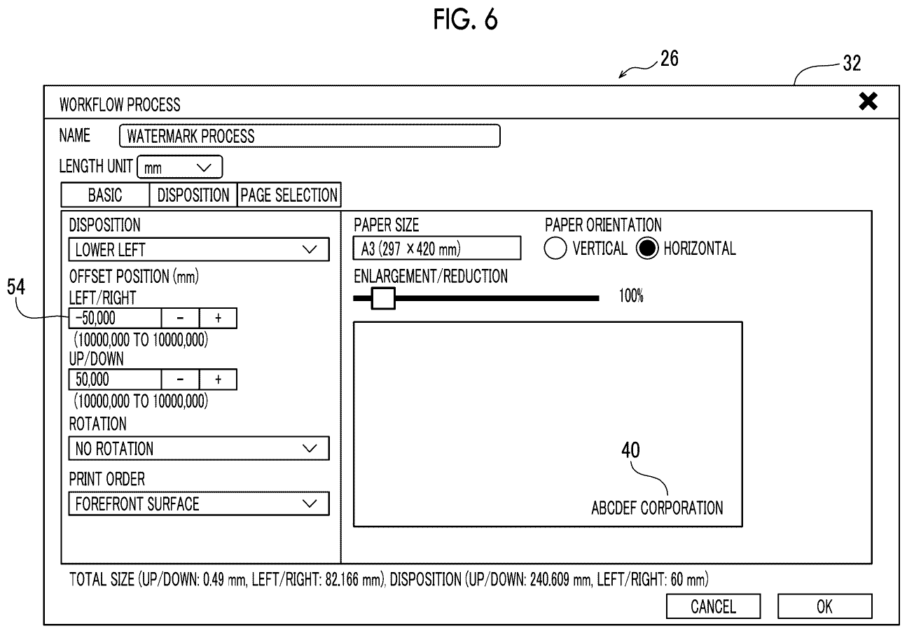

Specifically, in the attribute setting screen 32 of the processing icon (watermark) 70 (refer to FIG. 3) of the post-branching flow 102A of the replication source shown in FIG. 5, an item 54 of a left/right disposition position of the watermark 40 is “50,000”. However, in the attribute setting screen 32 of the processing icon (watermark) 70 (refer to FIG. 3) of the post-branching flow 102A of the replication source shown in FIG. 6, the item 54 of the left/right disposition position of the watermark 40 is automatically changed to “−50,000”.

In a case where the item 54 on the attribute setting screen 32 of FIG. 5 is “3,000”, the item 54 on the attribute setting screen 32 shown in FIG. 6 is automatically changed to “−3,000”.

Further, in a case where the attribute of the processing of the processing icon 70 is automatically changed by the replication mode 90, an automatically changed content may be displayed on the display unit 26.

### Automatic Change of Attribute of Processing According to Condition for Conditional Branching

Next, the automatic change of the attribute of the processing according to the condition for the conditional branching will be described.

In addition to the change of the attribute in the replication mode 90A, the attribute is automatically changed according to the condition for the conditional branching.

As shown in FIG. 3, in a case where the user selects one or a plurality of the processing icons 70 of one post-branching flow 102A after the branch icon 80 and replicates the selected processing icon 70 to the other post-branching flow 102B after the branch icon 80, an item that can be changed based on the condition for the conditional branching of the post-branching flow 102B, among the items of the attribute of the processing of the processing icon 70, is automatically changed based on the condition for the conditional branching of the post-branching flow 102B, and the processing icon 70 is replicated to the post-branching flow 102B, which is the replication destination, to be disposed.

In the example shown in FIG. 3, the condition of the branch icon 80, that is, the condition for the conditional branching is the color mode, and the condition of the color mode of the post-branching flow 102A is monochrome. Accordingly, each color mode-related item of the processing icon (job attribute) 70, the processing icon (watermark) 70, and the processing icon (printing) 70 is changed from a monochrome attribute to a color attribute, and the processing icons 70 are replicated to the post-branching flow 102B.

Specifically, the color mode-related item of the processing of the processing icon (job attribute) 70, for example, the manuscript data is changed from monochrome to color and the processing icon 70 is replicated. The color mode-related item of the processing of the processing icon (printing) 70, for example, a printer model item is changed from a monochrome printer to a color printer and is replicated. In addition, an item not related to the color mode is replicated without being changed. Further, since there is no color mode-related item in the processing of the processing icon (watermark) 70, the attribute is replicated without being changed.

In a case where the attribute of the processing of the processing icon 70 is automatically changed according to the condition for the conditional branching at the replication destination, an automatically changed content may be displayed on the display unit 26.

### Flowchart

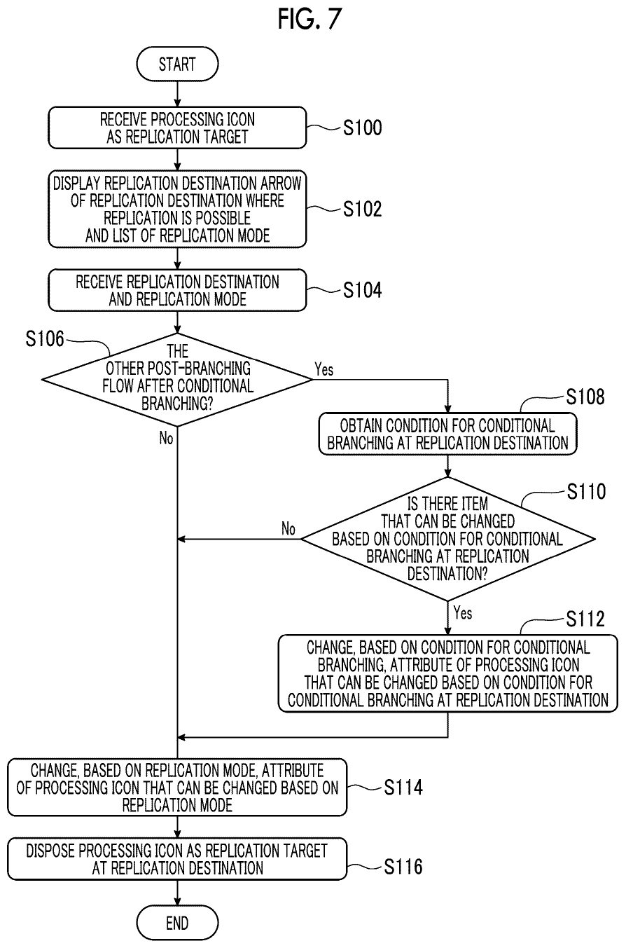

Next, replication processing performed by the information processing apparatus 10 according to the present exemplary embodiment will be described with reference to a flowchart shown in FIG. 7. The CPU 20A shown in FIG. 1 reads out the program from the ROM 20C or the storage unit 22, develops the program in the RAM 20B, and executes the program to perform the replication processing.

In step S100, the CPU 20A receives the processing icon 70 selected by the operation of the user as a replication target. In step S102, the CPU 20A displays the replication destination arrow 67 of the replication destination where the processing icon 70 as the replication target can be replicated by the operation of the user and the list 69 of the replication modes 90 (refer to FIG. 3). In step S104, the CPU 20A receives the replication destination and the replication mode 90, which are selected by the operation of the user.

In step S106, the CPU 20A checks whether or not the replication destination of the processing icon 70 as the replication target is the other post-branching flow. In a case where the replication destination thereof is not the other post-branching flow in step S106 (No), the processing proceeds to step S114.

In step S114, the CPU 20A changes, based on the replication mode 90, the attribute of the processing icon 70 that can be changed based on the replication mode 90.

In the example of FIG. 3 described above, the disposition conversion replication (left and right) 90B (refer to FIG. 3) is selected, and the processing icon capable of being subjected to the disposition conversion replication (left and right) 90B, among the processing icon (job attribute) 70, the processing icon (watermark) 70, and the processing icon (printing) 70, is the processing icon (watermark) 70. Thus, the left/right disposition of the watermark 40 (refer to FIGS. 4A and 4B) is switched.

In step S116, the CPU 20A disposes the processing icon 70 as the replication target whose attribute is changed at the replication destination.

In a case where the replication destination thereof is the other post-branching flow in step S106 described above (Yes), the processing proceeds to step S108. In step S108, the CPU 20A extracts and analyzes the condition for the conditional branching to obtain the condition for the conditional branching at the replication destination. In step S110, the CPU 20A checks, based on the condition for the conditional branching at the replication destination, whether or not there is an item that can be changed in the item of each piece of processing of the processing icon 70 as the replication target. In a case where there is no item that can be changed in step S110 (No), the processing proceeds to step S114. In a case where there is the item that can be changed in step S110 (Yes), the processing proceeds to step S112.

In step S112, the CPU 20A changes the item that can be changed based on the condition for the conditional branching at the replication destination, and proceeds to step S114.

In the example of FIG. 3 described above, each color mode-related item of the processing icon (job attribute) 70, the processing icon (watermark) 70, and the processing icon (printing) 70 is converted from the monochrome attribute to the color attribute, and the processing icons 70 are replicated to the post-branching flow 102B.

### Action

Next, an action of the present exemplary embodiment will be described.

In a case where the replication destination of the processing icon 70 as the replication target of the post-branching flow 102A is the post-branching flow 102B, the information processing apparatus 10 replicates and disposes the processing icon 70 whose item changeable based on the condition for the conditional branching of the post-branching flow 102B is changed, among the items of the attribute of the processing of the processing icon 70 as the replication target, to the post-branching flow 102B, which is the replication destination.

Specifically, in the present exemplary embodiment, in a case where the processing icon (job attribute) 70, the processing icon (watermark) 70, and the processing icon (printing) 70 of the post-branching flow 102A having the condition of the color mode, which is the conditional branching after the branching of the branch icon 80, of monochrome are replicated to the post-branching flow 102B having the condition of color, each color mode-related item of the processing icon (job attribute) 70 and the processing icon (printing) 70 is changed from the monochrome attribute to the color attribute, and the processing icons 70 are replicated to the post-branching flow 102B to be disposed.

Further, the information processing apparatus 10 changes, based on the replication mode 90, the attribute of the processing icon 70 that can be changed based on the replication mode 90 and replicates and disposes the processing icon 70 to the post-branching flow 102B, which is the replication destination.

Specifically, in the present exemplary embodiment, since the disposition conversion replication (left and right) 90B is selected, the left/right disposition of the watermark by the processing icon (watermark) 70 capable of being subjected to the disposition conversion replication (left and right) 90B, among the processing icon (job attribute) 70, the processing icon (watermark) 70, and the processing icon (printing) 70, is switched from the post-branching flow 102A of the replication source, and the processing icon 70 is replicated to the post-branching flow 102B of the replication destination to be disposed.

Further, on the attribute setting screen 32, each item of the attribute of each processing may be set.

### Others

The present invention is not limited to the above-described exemplary embodiments.

For example, the information processing apparatus 10 according to the above-described exemplary embodiment is used for creating the pre-press workflow 100, but the present disclosure is not limited thereto. The information processing apparatus 10 may be used for creating a workflow of each printing step other than the pre-press, or may be used for creating a workflow other than the printing step such as post-process, inspection, shipment, or the like after printing.

Further, for example, the replication mode of the above-described exemplary embodiment is not limited to the three modes of the replication mode 90A of performing the simple replication, the replication mode 90B of performing the disposition conversion replication (left and right), and the replication mode 90C of performing the disposition conversion replication (up and down). Examples of other replication modes include the following (A) to (G).
(A) Replication Mode of Changing Binding Direction

A binding direction in bookbinding is changed.
(B) Replication Mode of Changing N-Page Imposition

A two-page imposition is changed to a four-page imposition, and a single-side is changed to a double-side.
(C) Replication Mode of Changing Size

A paper size is changed. A related item may be changed together with the change of the paper size. An example includes automatic adjustment in a case where enlargement/reduction or an installation position of a barcode or the like exceeds a range. Further, the page imposition may be changed to match the paper size. For example, in a case where the page imposition before the change is a two-page imposition for the paper size of A4, the page imposition is automatically adjusted to a four-page imposition in a case where the paper size is A3 after the change.
(C) Replication Mode of Performing Enlargement/Reduction

Enlargement or reduction is simply performed regardless of a background size or the like.
(D) Replication Mode of Performing Monochromatization

A full color mode is changed to a grayscale mode.
(F) Replication Mode of Performing Left/Right Inversion Left/right inversion is performed.
(G) Replication Mode of Performing Up/Down Inversion

Up/down inversion is performed.

Further, for example, in the above-described exemplary embodiment, the aspect has been described in which the program of the image processing is stored (installed) in advance in the ROM or the storage, but the present disclosure is not limited thereto. The program may be provided in a form of being recorded on a recording medium such as a compact disk read only memory (CD-ROM), a digital versatile disk read only memory (DVD-ROM), and a universal serial bus (USB) memory. Further, the program may be downloaded from an external device via a network, such as the Internet.

Further, for example, the various processors other than the CPU may execute the processing read and executed by the CPU 20A in the above-described exemplary embodiment.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, the operations of the processor may be executed by a combination of two or more processors of the same type or different types (for example, a plurality of FPGAs, a combination of a CPU and an FPGA). Further, more specifically, a hardware structure of these various processors is an electric circuit in which circuit elements such as semiconductor elements are combined.

Furthermore, the present invention can be implemented in various aspects without departing from the concept of the present invention. The plurality of exemplary embodiments, modification examples, and the like can be combined and implemented as appropriate.

### Supplementary Notes

((1)

An information processing system comprising:
one or a plurality of processors configured to:
   display a workflow in which a processing icon representing processing and a branch icon representing branching by a conditional branching are arranged;
   receive the processing icon included in a post-branching flow of one condition after the branching of the branch icon as a replication target; and
   in a case where a replication destination of the processing icon as the replication target is a post-branching flow of the other condition after the branching, dispose the processing icon whose item changeable based on the other condition, among items of an attribute of processing of the processing icon as the replication target, is changed from the one condition, based on the other condition, at the replication destination.
(((2)))

The information processing system according to (((1))), wherein the processor is configured to:
display, in a case where the processing icon included in the post-branching flow of the one condition is received as the replication target, a list of replication modes of changing the attribute; and
in a case where the replication destination of the processing icon as the replication target is the post-branching flow of the other condition, change the item changeable according to the other condition from the one condition according to the other condition and change, based on the replication mode selected from the list, the attribute of the processing icon whose attribute is changeable based on the replication mode to dispose the processing icon at the replication destination.
(((3)))

The information processing system according to (((2))), wherein the processor is configured to:
display a setting screen for setting the item of the attribute to be changed in the replication mode.
(((4)))

The information processing system according to any one of (((1))) to (((3))), wherein the processor is configured to:
display, in a case where the processing icon included in the post-branching flow of the one condition is received as the replication target, a replication destination where the replication is possible; and
in a case where a selected replication destination is the post-branching flow of the other condition, dispose the processing icon whose item changeable based on the other condition, among the items of the attribute of the processing of the processing icon as the replication target, is changed from the one condition, based on the other condition, at the replication destination.
(((5))

The information processing system according to any one of (((1)) to ((4))), wherein the processor is configured to:
display, in a case where the replication destination is selected, a list of replication modes of changing the attribute; and
in a case where the selected replication destination is the post-branching flow of the other condition, change the item changeable based on the other condition, among the items of the attribute of the processing of the processing icon as the replication target, from the one condition based on the other condition and change, based on the replication mode selected from the list, the attribute of the processing icon whose attribute is changeable based on the replication mode to dispose the processing icon at the replication destination.
(((6)))

The information processing system according to (((5)), wherein the processor is configured to:
display a setting screen for setting the item of the attribute to be changed in the replication mode.
(((7)))

A program causing a computer to implement:
displaying a workflow in which a processing icon representing processing and a branch icon representing branching by a conditional branching are arranged;
receiving the processing icon included in a post-branching flow of one condition after the branching of the branch icon as a replication target; and
in a case where a replication destination of the processing icon as the replication target is a post-branching flow of the other condition after the branching, disposing the processing icon whose item changeable based on the other condition, among items of an attribute of processing of the processing icon as the replication target, is changed from the one condition, based on the other condition, at the replication destination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
one or a plurality of processors configured to:
display a workflow in which a processing icon representing processing and a branch icon representing branching by a conditional branching are arranged;
receive the processing icon included in a post-branching flow of one condition after the branching of the branch icon as a replication target; and
in a case where a replication destination of the processing icon as the replication target is a post-branching flow of the other condition after the branching, dispose the processing icon whose item changeable based on the other condition, among items of an attribute of processing of the processing icon as the replication target, is changed from the one condition, based on the other condition, at the replication destination.

2. The information processing system according to claim 1, wherein the processor is configured to:
display, in a case where the processing icon included in the post-branching flow of the one condition is received as the replication target, a list of replication modes of changing the attribute; and
in a case where the replication destination of the processing icon as the replication target is the post-branching flow of the other condition, change the item changeable according to the other condition from the one condition according to the other condition and change, based on the replication mode selected from the list, the attribute of the processing icon whose attribute is changeable based on the replication mode to dispose the processing icon at the replication destination.

3. The information processing system according to claim 2, wherein the processor is configured to:
display a setting screen for setting the item of the attribute to be changed in the replication mode.

4. The information processing system according to claim 1, wherein the processor is configured to:
display, in a case where the processing icon included in the post-branching flow of the one condition is received as the replication target, a replication destination where the replication is possible; and
in a case where a selected replication destination is the post-branching flow of the other condition, dispose the processing icon whose item changeable based on the other condition, among the items of the attribute of the processing of the processing icon as the replication target, is changed from the one condition, based on the other condition, at the replication destination.

5. The information processing system according to claim 4, wherein the processor is configured to:
display, in a case where the replication destination is selected, a list of replication modes of changing the attribute; and
in a case where the selected replication destination is the post-branching flow of the other condition, change the item changeable based on the other condition, among the items of the attribute of the processing of the processing icon as the replication target, from the one condition based on the other condition and change, based on the replication mode selected from the list, the attribute of the processing icon whose attribute is changeable based on the replication mode to dispose the processing icon at the replication destination.

6. The information processing system according to claim 5, wherein the processor is configured to:
display a setting screen for setting the item of the attribute to be changed in the replication mode.

7. A non-transitory computer readable medium storing a program causing a computer to implement:
displaying a workflow in which a processing icon representing processing and a branch icon representing branching by a conditional branching are arranged;
receiving the processing icon included in a post-branching flow of one condition after the branching of the branch icon as a replication target; and
in a case where a replication destination of the processing icon as the replication target is a post-branching flow of the other condition after the branching, disposing the processing icon whose item changeable based on the other condition, among items of an attribute of processing of the processing icon as the replication target, is changed from the one condition, based on the other condition, at the replication destination.

8. An information processing method comprising:
displaying a workflow in which a processing icon representing processing and a branch icon representing branching by a conditional branching are arranged;
receiving the processing icon included in a post-branching flow of one condition after the branching of the branch icon as a replication target; and
in a case where a replication destination of the processing icon as the replication target is a post-branching flow of the other condition after the branching, disposing the processing icon whose item changeable based on the other condition, among items of an attribute of processing of the processing icon as the replication target, is changed from the one condition, based on the other condition, at the replication destination.
